(19) United States
(12) Patent Application Publication
(10) Pub. No.: US 2018/0121155 A1
(43) Pub. Date: May 3, 2018

(54) HELMET FOR A SMART CYCLING EQUIPMENT

(71) Applicant: Shenzhen Qianhai LIVALL IoT Technology Co., Ltd., Shenzhen City (CN)

(72) Inventors: BO ZHENG, Shenzhen City (CN); YONG-ZHENG YE, Shenzhen City (CN); JIE TIAN, Jiujiang City (CN); ZHI-MING LI, Nanchong City (CN); XIANG-LING YI, Xiamen City (CN)

(21) Appl. No.: 15/390,716

(22) Filed: Dec. 26, 2016

(30) Foreign Application Priority Data
Oct. 31, 2016 (CN) 201621201470.5

(51) Int. Cl. G06F 3/16; H04R 1/02; A42B 3/30

(52) U.S. Cl. CPC G06F 3/165; H04R 1/026; H04R 2201/107; A42B 3/306; A42B 3/303

(57) ABSTRACT

A helmet for a smart cycling equipment. The helmet includes a main body, a left speaker, a right speaker, a control interface, a charging interface, a microprocessor, a wireless communication module, and a battery. The main body includes a shell and a flange connected to the shell and surrounding the shell. The flange includes a front portion, a rear portion, a left portion, and a right portion. The left speaker is arranged on the left portion. The right speaker is arranged on the right portion. The control interface and the charging interface are arranged on the flange. The wireless communication module is connected to the microprocessor. The battery is connected to the charging interface.

### CROSS-REFERENCE TO RELATED APPLICATION AND CLAIM OF PRIORITY

This application claims priority of a China patent application serial No. 201621201470.5, titled “SMART HELMET WITH COMMUNICATION FUNCTION” and filed on Oct. 31, 2016, the contents of which are incorporated by reference herein in their entirety for all intended purposes.

### TECHNICAL FIELD

The present disclosure relates to cycling equipment, and more particularly, to a helmet for a cycling equipment.

### BACKGROUND

Cycling is very popular among young people, and has become a popular outdoor sports around the world. However, it is very inconvenient for a cyclist to pick up a phone call during cycling. Besides, it is quite dangerous for the cyclist to pick up a phone call by operating a smart phone using a hand, as distracted attention in cycling may cause an accident. Therefore, the cyclist likes to wear a bluetooth headset to listen to music. However, although listening to music is enjoyable, but it may negatively affect the cyclist's perception of an ambient environment (such as external sound). For example, the cyclist wearing a bluetooth headset may not hear vehicle sound behind, which may result in a risk of a crash.

### BRIEF DESCRIPTION OF THE DRAWINGS

To illustrate the technical solution according to embodiments of the present disclosure more clearly, drawings to be used in the description of the embodiments are described in brief as follows. Obviously, the drawings in the following description are merely some embodiments of the present disclosure. It is to be noted that for those ordinarily skilled in the art, other drawings can be fetched according to these drawings without doing any creative work.

FIG. 1 is a schematic view of a helmet, according to a first embodiment of the present disclosure;

FIG. 2 is a schematic view of the helmet shown in FIG. 1, showing a connecting relationship thereof.

### PREFERRED EMBODIMENTS

The technical solution in the embodiments of the present disclosure will be described clearly and completely accompanying with drawings of embodiments of the present disclosure as follows. Apparently, the described embodiments are only a part of the embodiments of the present disclosure, but not all the embodiments. Based on the embodiments of the present disclosure, all other embodiments achieved by those ordinarily skilled in the art without doing any creative work, should be included in the scope of the present disclosure.

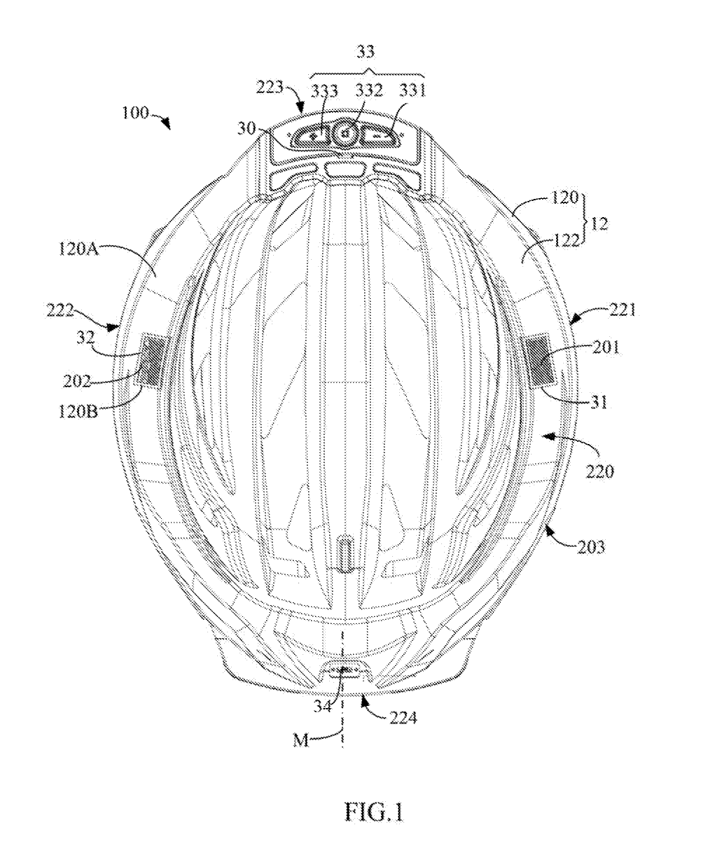

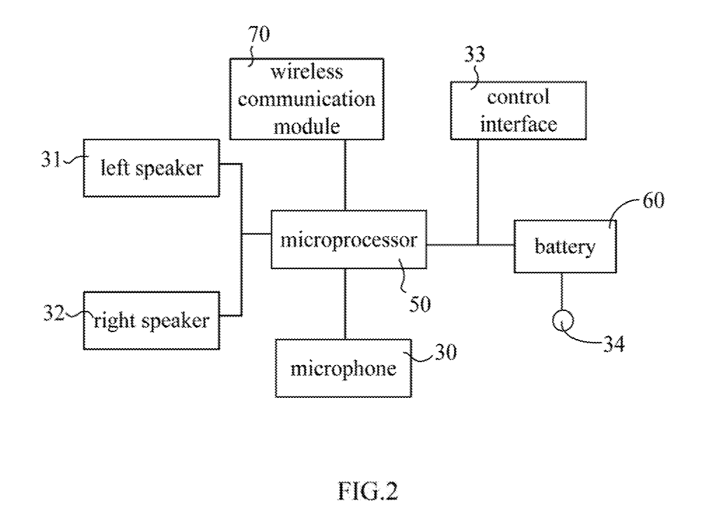

Referring to FIG. 1 and FIG. 2, a helmet 100 according to an embodiment of the present disclosure includes a main body 12, a control module 50, and a battery 60 (see FIG. 2).

The main body 12 includes a shell 120 and a flange 122. The shell 120 is substantially spherical, and is used to cover a portion of a cyclist's head, thus protecting the head from external impact. The flange 122 is connected to a bottom side of the shell 120, and surrounds the shell 120. In this embodiment, the shell 120 and the flange 122 are integrally made by using plastic, such as PC (Polycarbonate) or EPS (Expanded Polystyrene), or other suitable material.

In this embodiment, the flange 122 includes an outer surface 120A. In addition, the flange 122 includes a front portion 223, a rear portion 224, a left portion 221, and a right portion 222. The front portion 223 and the rear portion 224 are located at opposite sides of the shell 120. The left portion 221 and the right portion 222 are located at another opposite sides of the shell 120. In use, the front portion 223 and the rear portion 224 are spatially relation to a forehead and a back side of head respectively, and the left portion 221 and the right portion 222 are spatially relation to ears of the cyclist respectively.

In addition, each of the left portion 221 and the right portion 222 is located between the front portion 223 and the rear portion 224. Two recesses 120B are defined in outer surface 120A at the left portion 221 and the right portion 222, respectively.

In this embodiment, the helmet 100 further includes a microphone 30, a left speaker 31, a right speaker 32, a control interface 33, and a charging interface 34. The control interface 33 and the charging interface 34 are located in a central axis M of the helmet 100. Generally, the microphone 30 and the control interface 33 are arranged on the front portion 223, and are adjacent to each other. The left speaker 31 is arranged on the left portion 221. The right speaker 32 is arranged on the right portion 222.

The left speaker 31 and the right speaker 32 are symmetric about the central axis M of the helmet 100. In use, the left speaker 31 is received in the recess 120B of the left portion 221, and the right speaker 32 is received in the recess 120B of the right portion 222. The recess 120B is substantially rectangular.

The helmet 100 further includes a left dust filter 201 and a right dust filter 202 (with a number of holes therein). The left dust filter 201 and the right dust filter 202 are fittingly received in the two recesses 120B respectively. In use, the left dust filter 201 and the right dust filter 202 are used to prevent dust from entering the recesses 120B. Preferably, an external surface of the left dust filter 201 or the right dust filter 202 is coplanar with the outer surface 120A of the flange 122.

In this embodiment, the control interface 33 includes a switch button 332, a first volume button 331, and a second volume button 333. The switch button 332 is located between the first volume button 331 and the second volume button 333. Preferably, the switch button 332, the first volume button 331, and the second volume button 333 protrude from the outer surface 120A.

The microprocessor 50 and the battery 60 are secured inside the main body 12.

As shown in FIG. 2, each of the microphone 30, the left speaker 31, the right speaker 32, the control interface 33, and the battery 60 is connected to the microphone 30. The charging interface 34 is further connected to the battery 60. In use, the charging interface 34 can be electrically connected to an external power source (not shown). In this way, the external power source can be used to charge electricity to the battery 60, and the battery 60 supplies power to the microphone 30, the left speaker 31, the right speaker 32, and the microprocessor 50.

In this embodiment, the helmet 100 may further include a wireless communication module 70 connected to the microprocessor 50. The communication module 70 is used to be wirelessly connected to a client, such as a smart phone (not shown) by, for example, bluetooth, WIFI, or other communication mode, such as Zigbee. In one example, the wireless communication module 70 can be a bluetooth chip.

In one typical application, a switch button 332 is pressed by the cyclist to switch on the communication module 70 during cycling. Accordingly, a wireless communication is established between the smart phone and the communication module 70. When an incoming call (from for example, another cyclist) is received by the smart phone, the smart phone generates a ring tone to warn the cyclist. The cyclist may press the switch button 332 to pick up the phone call.

On one hand, when the cyclist speaks to the microphone 30, an audio signal is generated by the microphone 30, and further transmitted to the smart phone by the communication module 70. On the other hand, an audio signal from the smart phone may be transmitted to the microprocessor 50 via the communication module 70. The audio signal is broadcasted by the left speaker 31 and the right speaker 32 toward ears of the cyclist. In this manner, the cyclist can pick up a phone call and hear a voice from the left speaker 31 and the right speaker 32 without wearing a headset during cycling, thus avoiding an accident caused by distracted attention.

In use, the cyclist may press the first volume button 331 to decrease a volume of the left and the right speakers 31, 32, or press the second volume button 332 to increase the volume of the left and the right speakers 31, 32 simultaneously.

In another typical application, the cyclist may use the helmet 100 to listen to music played by the smart phone. The first volume button 331 or the second volume button 332 may be pressed to decrease or increase a volume of the music.

In alternative embodiments, the control interface 33 may include other buttons (not shown) for other functions. For example, the control interface 33 may include buttons for switching to a “next” or a “previous” song.

In still alternative embodiments, the helmet 100 may include a secondary microphone (not shown) arranged, for example, at a rear portion 224 of the flange 122 (so it doesn't pick up so much speech). In this manner, the microphone 30 serves as a primary microphone, and the microphone 30 and the secondary microphone cooperate to remove background noise during the call.

The contents described above are only preferred embodiments of the present disclosure, but the scope of the present disclosure is not limited to the embodiments. Any ordinarily skilled in the art would make any modifications or replacements to the embodiments in the scope of the present disclosure, and these modifications or replacements should be included in the scope of the present disclosure. Thus, the scope of the present disclosure should be subjected to the claims.

What is claimed is:

1. A helmet for a smart cycling equipment, comprising:
a main body, the main body including a shell and a flange connected to the shell and surrounding the shell, the flange including a front portion, a rear portion, a left portion, and a right portion;
a left speaker arranged on the left portion of the flange;
a right speaker arranged on the right portion of the flange;
a control interface and a charging interface arranged on the flange;
a microprocessor;
a wireless communication module connected to the microprocessor; and
a battery connected to the charging interface.

2. The helmet of claim 1, wherein the front portion and the rear portion are located at opposite sides of the shell, and the left portion and the right portion are located at another opposite sides of the shell, and each of the left portion and the right portion is located between the front portion and the rear portion.

3. The helmet of claim 2, wherein the control interface is arranged on the front portion of the flange, and the control interface is arranged on the rear portion of the flange.

4. The helmet of claim 2, wherein two recesses are defined in an outer surface of the flange at the left portion and the right portion for receiving the left speaker and the right speaker respectively.

5. The helmet of claim 4, further comprising a left dust filter and a right dust filter fittingly received in the two recesses respectively.

6. The helmet of claim 5, wherein an external surface of the left dust filter or the right dust filter is coplanar with the outer surface of the flange.

7. The helmet of claim 1, wherein the control interface includes a switch button, a first volume button, and a second volume button, and the switch button is located between the first volume button and the second volume button.

8. The helmet of claim 1, wherein the microprocessor, the wireless communication module, and the battery are secured inside the main body.

9. The helmet of claim 1, wherein the wireless communication module is a bluetooth chip.

10. The helmet of claim 1, further comprising a microphone arranged on the front portion of the flange adjacent to the control interface.

11. The helmet of claim 10, further comprising a secondary microphone arranged on the rear portion of the flange.
